(19) United States
(12) Patent Application Publication
(10) Pub. No.: US 2019/0251618 A1
(43) Pub. Date: Aug. 15, 2019

(54) MERCHANDISE SHOWING IMAGE DISPLAY METHOD, DISPLAY INFORMATION GENERATION SERVER DEVICE, AND IMAGE DISPLAY SYSTEM

(71) Applicant: NEC Display Solutions, Ltd, Tokyo (JP)

(72) Inventor: Hideki TERAMATSU, Tokyo (JP)

(21) Appl. No.: 16/320,053

(22) PCT Filed: Jul. 29, 2016
(86) PCT No.: PCT/JP2016/072312

§ 371 Date: Jan. 23, 2019

(51) Int. Cl. G06Q 30/06

(52) U.S. Cl. CPC G06Q 30/0639; G06Q 30/0641

(57) ABSTRACT

An information supply method includes supplying a store with merchandise showing information. The merchandise showing information indicates merchandise sold at the store and a position at which a merchandise image is displayed. The position is a position on a merchandise showing screen of a display system provided at the store. The merchandise image is an image of the merchandise.

### TECHNICAL FIELD

The present invention relates to a merchandise showing image display method for displaying an image of a merchandise on an image display device such as a liquid crystal display monitor, a display information generation server device, and an image display system.

### BACKGROUND ART

In recent years, image display devices such as liquid crystal display monitors have been employed for showing merchandise to be sold in retail stores typified by supermarkets and convenience stores (for example, refer to Patent Document 1).

Also, when showing merchandise on a display screen of an image display device, the arrangement of showing merchandise on this display screen, in general, is laid out uniquely at each store.

### PRIOR ART DOCUMENTS

### [Patent Documents]

[Patent Document 1] Japanese Unexamined Patent Application, First Publication No. 2015-201115

### SUMMARY OF THE INVENTION

### Problem to be Solved by the Invention

The problems to be solved are as follows. When laying out an arrangement of merchandise on an image display device for each store, sales performance is confirmed on a POS (point of sale) system and hot-selling merchandise are extracted. According to the result of this, the arrangement of merchandise is performed at each store in order to improve sales.

However, confirming sales performance on the POS system at each store and extracting hot-selling merchandise is burdensome, and know-how is required for arranging when displaying the merchandise in a manner that improves sales. Therefore, it is difficult to independently perform merchandise arrangement at each store.

### Means for Solving the Problem

The present invention is an information supply method for supplying a store with merchandise showing information, the merchandise showing information indicating merchandise sold at the store and a position at which a merchandise image is displayed, the position being a position on a merchandise showing screen of a display system provided at the store, the merchandise image being an image of the merchandise.

The present invention is a display information generation server device that is provided at a head office that administers a store, and that supplies the store with merchandise showing image information, the merchandise showing information indicating merchandise sold at the store and a position at which a merchandise image is displayed, the position being a position on a merchandise showing screen of a display system provided at the store, the merchandise image being an image of the merchandise.

The present invention is an image display system that includes one or a plurality of image display devices provided in a store, and that includes: a merchandise showing screen constituted by a display screen of the image display devices; and an image information control unit that displays an image of merchandise on the merchandise showing screen based on merchandise showing information, the merchandise showing information indicating merchandise sold at the store and a position at which a merchandise image is displayed, the position being a position on a merchandise showing screen of a display system provided at the store, the merchandise image being an image of the merchandise.

### Effect of the Invention

According to the present invention, it is possible to arrange images of merchandise on a merchandise showing screen on the basis of sales performance confirmation by POS system register information of a head office (sales information on an electronic register), and merchandise showing image information that indicates a configuration of merchandise showing display images generated by a specialized staff having know-how of extracting hot-selling merchandise. Therefore, there is no need for confirming sales performance on the POS system at each store, or extracting hot-selling merchandise, and it is possible to easily obtain an arrangement of images on the merchandise showing screen when showing merchandise for improving sales.

### BRIEF DESCRIPTION OF THE DRAWINGS

FIG. 1 is a diagram showing a configuration example of a display information generation server and an image display system according to an exemplary embodiment of the present invention.

FIG. 2 is a diagram showing a configuration example of store analysis data tables stored in a store analysis database 13.

FIG. 3 is a diagram showing a configuration example of tables related to merchandise showing, stored in a showing image database.

FIG. 4 is a diagram showing an example of a merchandise showing screen of an image display unit 22 constituted by one image display device.

FIG. 5 is a diagram showing another example of the merchandise showing screen in which merchandise categories are associated.

FIG. 6 is a diagram showing another example of the merchandise showing screen in which merchandise categories are associated.

FIG. 7 is a diagram showing another example of the merchandise showing screen in which merchandise categories are associated.

FIG. 8 is a diagram for describing a concept of an exemplary embodiment of the present invention.

### EMBODIMENTS FOR CARRYING OUT THE INVENTION

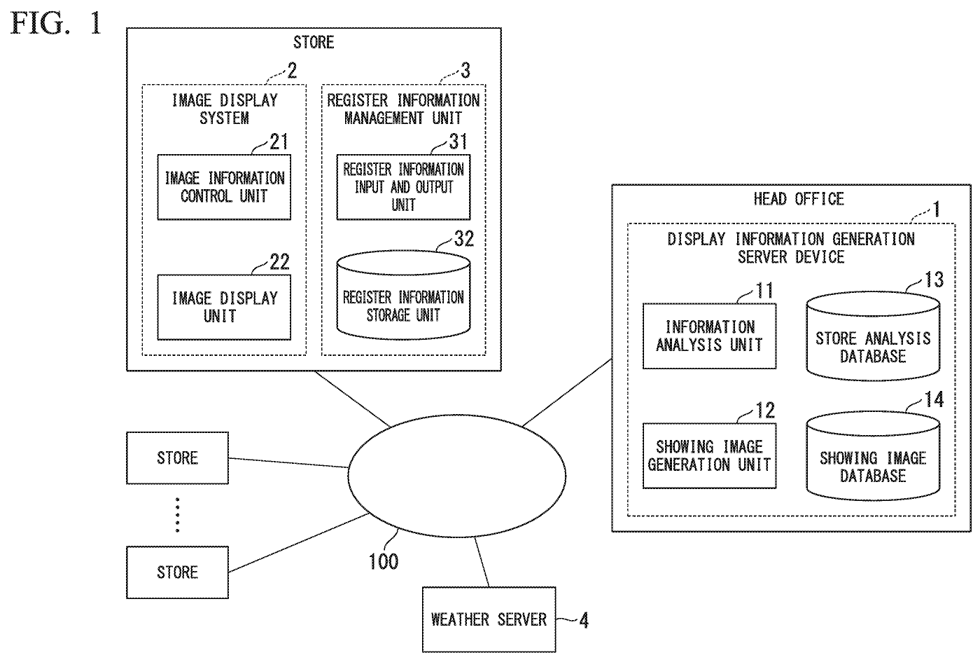

Hereunder, a display information generation server and an image display system for displaying merchandise images according to an exemplary embodiment of the present invention is described, with reference to the drawings. FIG. 1 is a diagram showing a configuration example of a display information generation server and an image display system according to the exemplary embodiment of the present invention.

As shown in FIG. 1, a display information generation server device 1 is a server device provided at a head office that administers stores, and includes an information analysis unit 11, a showing image generation unit 12, a store analysis database 13, and a showing image database 14 respectively. An image display system 2 is provided in each of the stores administered by the head office, and each is provided with an image information control unit 21 and an image display unit 22. In addition, at the store there is provided a register information management unit 3 having functions such as a POS system. This register information management unit 3 includes a register information input and output unit 31 and a register information storage unit 32. A weather server 4 is provided in a weather forecast company and provides weather forecast information for the week, the next day, or the present day. A network 100 is an information communication network including the Internet, and is connected to the display information generation server device 1, the image display system 2, the register information management unit 3, the weather server 4, and the like.

The information analysis unit 11 temporarily writes and stores in the store analysis database 13, register information supplied periodically (for example, every day) from the register information management unit 3 of each store. Then, by means of the information analysis unit 11, an operator at the head office reads out the register information from the store analysis database 13 for each store, aggregates and analyzes the read register information, and finds the sale situation of the goods at each store. This operator at the head office is a specialized staff with know-how for checking sales performance in a POS system, and extracting hot-selling merchandise.

The register information is information indicating sales of merchandise for each customer input to an electronic register at each store (sales information), and is shown as sales information for selling merchandise to each customer. It is information including at least the type of merchandise sold to the customer, the number of purchases for each type of merchandise, the gender and age of the customer, the time period of purchase, and the weather at the time of purchase. The sales situation is information in which information on sales of merchandise to customers are aggregated at least for each season (month and date), each day of the week, each weather, and each time period, using the register information of a certain past period (for example, one year) as a history, and is information such as the number of people for each gender that purchased the merchandise in each time period, the type of merchandise purchased, the average sales amount, and the total sales amount. This sales situation is not particularly limited in terms of type as long as it is arbitrarily extracted as information required for analysis by an operator of the head office, and is information that is used for generating merchandise showing information which is information for displaying merchandise images of merchandise sold at each store, on a display screen (merchandise showing screen described later) of the image display device provided at the store.

When generating merchandise showing information, the showing image generation unit 12 of the display information generation server device 1 accesses the weather server 4 and confirms weather forecast for each time period in an area in which each store on a target generation day is located. Then, the showing image generation unit 12, with use of combinations of season (month and date), day of the week, weather, and time of period corresponding to the merchandise showing information generation target date and time, for each store, extracts the history of sales situation in the store analysis database 13, and aggregates the number of merchandises sold and displays this on the display screen. The showing image generation unit 12 analyzes the displayed aggregated result and thereby finds merchandise that sold well (hot-selling merchandise), featured merchandise, and the like at each store. Based on the analysis result, the showing image generation unit 12, by means of an image generation function of the showing image generation unit 12, generates a display position (a category region and an individual region described later) for displaying the display image of merchandise on the display screen of the image display device of each store so as to correspond to the image display device in each store. The processing of the display information generation server device 1 described above may be performed by an operator at the head office performing an operation on the display screen of the display information generation server device 1.

In the register information management unit 3, the register information input and output unit 31 writes, stores, and accumulates in the register information storage unit 32, register information for each customer to whom merchandise has been sold and which is input by a store staff of the store. Moreover, the register information input and output unit 31 reads out accumulated register information from the storage unit periodically (for example, every day), and outputs the read register information to the display information generation server device 1 of the head office.

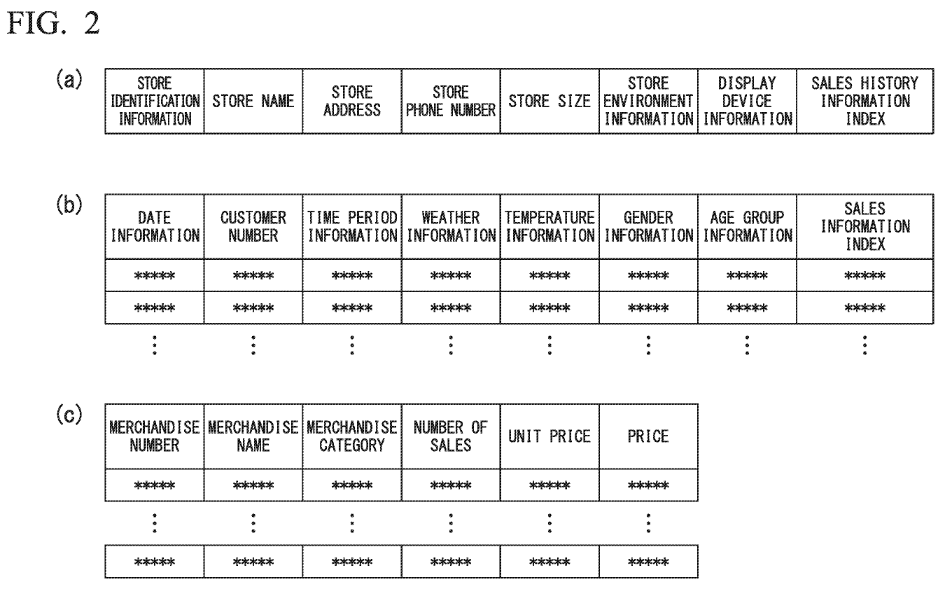

FIG. 2 is a diagram showing a configuration example of store analysis data tables stored in the store analysis database 13. The store analysis data table is provided for each store, and is identified by store identification information, and is given a store name. The store analysis data table has tables including the store table shown in FIG. 2 (a), the store sales history table shown in FIG. 2 (b), and the per-customer sales table shown in FIG. 2 (c) respectively.

The store table in FIG. 2 (a) has items including store name, store address, store phone number, store size, store environment information, image display device information, and sales history information index respectively, corresponding to the store identification information. The store identification information indicates identification information for identifying each of the stores administered by the head office. The store name indicates the name of a store identified in the store identification information. The store address indicates the address where the store is located. The store phone number indicates the phone number of the telephone provided in the store. The store size indicates each classification of stores administered by the head office such as large size store, medium size store, and small size store, by the magnitude of the store size based on the store area of each store. The store environment information indicates information that enables prediction of customer demographics and the number of customers that make purchases, the information including whether the area where the store is located is a residential area, a commercial area, or an industrial area and whether or not there are schools (such as an elementary school, a junior high school, a senior high school, a university, and a vocational school) near the store. The image display device information is information of the image display device installed in the store, and indicates device identification information for identifying the image display device, the size of the display screen of the image display device indicated by the device identification information, and the position of installation thereof in the store, in association with each other. The sales history information index indicates a region in which information on sales history of each store is stored.

In FIG. 2 (b), the store sales history table is a table showing sales information for each date as a sales history, and includes items such as customer number, time period information, weather information, temperature information, gender information, age group information, and sales information index, so as to correspond to the date information. The date information indicates information of the year, month, and date on which the sale was made. The customer number indicates a serial number of a customer to whom merchandise has been sold on the same date. The time period information indicates a time period (or time) in which the customer made the payment. The weather information indicates the weather at a time when the customer made the payment. The temperature information indicates the outside temperature at a time when the customer made the payment. The gender information indicates the gender of the customer to whom the merchandise has been sold. The age group information is information indicating age groups (such as high age group, middle age group, and low age group) according to a certain age range of customers. The sales information index indicates a region in which information on merchandise and the like that have been sold to each customer is stored.

In FIG. 2 (c), the per-customer sales table is a table showing information on merchandise sold to a customer identified by a customer number and information on the sales amount thereof, and has items including merchandise name, merchandise category, number of sales, unit price, sales amount, and total sales amount respectively so as to correspond to a merchandise number. The merchandise number indicates identification information for identifying a merchandise used in the POS system. The merchandise name indicates the name of an item corresponding to the item number. The merchandise category indicates a category (type) of merchandise, such as box lunch, drink, and stationery. The number of sales indicates the number of purchases of a merchandise indicated by a merchandise number, made by customers. The unit price indicates the price of one piece of merchandise indicated by the merchandise number. The sales amount indicates an amount obtained by multiplying the unit price of the corresponding merchandise by the number of items sold. The total sales amount is the sum of the sales amounts of all the merchandise sold to a customer indicated by the customer number.

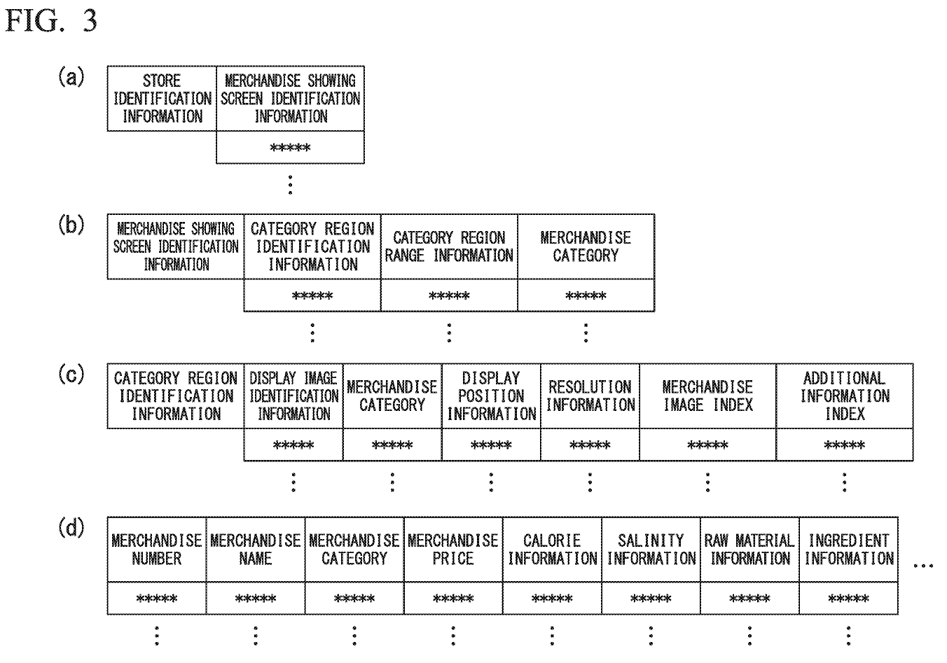

FIG. 3 is a diagram showing a configuration example of tables related to merchandise showing stored in the showing image database. Tables related to merchandise showing are provided for each store, and include a merchandise showing screen table shown in FIG. 3 (a), a category region table shown in FIG. 3 (b), a merchandise showing information table shown in FIG. 3 (c), and a merchandise attribute information table shown in FIG. 3 (d).

The merchandise showing screen table shown in FIG. 3 (a), so as to correspond to the store identification information, shows merchandise showing screen identification information which is identification information of each merchandise showing screen provided at the store indicated by the store identification information. The merchandise showing screen is a composite display screen that combines the display screen of one image display device or the display screens of a plurality of image display devices. One or a plurality of the merchandise showing screens are provided for each store. The position on the merchandise showing screen is set as a coordinate value, for example, the arrangement position of each of the image display devices and the two-dimensional arrangement of the pixels on the display screen of the image display device.

The category region table shown in FIG. 3 (b) is provided for each merchandise showing screen, and each of the category region identification information, the category region range information, and the merchandise category information are associated with each other. The category region identification information is identification information for identifying each of category regions separated on the merchandise showing screen. The category region range information is information indicating the position of a region occupied by the category region indicated by the category region identification information, on the merchandise showing screen. The merchandise category indicates the category of a merchandise associated with the category region. That is to say, the merchandise category indicates the category of a merchandise displayed in the category region. One or a plurality of merchandise categories can be associated with the category region. In addition, a plurality of category region tables may exist for one merchandise showing screen with a purpose of use and the like. That is to say, a plurality of category regions may be set in a duplicated manner on the merchandise showing screen according to the purpose.

The merchandise showing information table shown in FIG. 3 (c) is provided for each category region identification information, and includes, corresponding to display image identification information, a merchandise category, a display position information, resolution information, a merchandise image index, and an additional information index respectively. The display image identification information is identification information for identifying a merchandise image to be shown and displayed on the image display device. The merchandise category indicates the category of a merchandise of the merchandise image. The display position information is information for identifying a position for displaying a merchandise image indicated by the display image identification information, on the display screen of the image display device. The resolution information is information indicating the resolution of the merchandise image when displayed on the display screen of the image display device. The merchandise image index indicates the address of a location where the merchandise image corresponding to the display image identification information is stored. The additional information index indicates the address of a location where the attribute information for the merchandise of the displayed merchandise image is stored.

The merchandise attribute information table shown in FIG. 3 (d) is provided for each display image, and includes merchandise name, merchandise category, merchandise price, calorie information, salinity information, raw material information, and the ingredient information respectively. The merchandise number indicates identification information for identifying a merchandise used in the POS system. The merchandise name indicates the name of an item corresponding to the item number. The merchandise category indicates a category (type) of merchandise, such as box lunch, drink, and stationery. The merchandise price indicates the unit price of a merchandise. The calorie information indicates the caloric content of the merchandise when the merchandise category is food. The salinity information indicates the salt content of the merchandise when the merchandise category is food. The raw material information indicates each of the raw materials and ingredients used in manufacturing the merchandise. For ingredient information, food ingredients such as nutrient contents, colors, and scent components are indicated for foods, for example.

Returning to FIG. 1, as described above, the showing image generation unit 12 of the display information generation server device 1 aggregates the data of the register information of the store analysis table stored in the store analysis database 13, analyzes the sales situation such as the number of sales and the sale amount of each merchandise by season (month and date), day of the week, and weather so as to correspond to the date and time period of the merchandise showing information generation target, and generates the merchandise showing information. At this time, the showing image generation unit 12 of the display information generation server device 1 not only ranks the aggregated and extracted hot-selling merchandise, the number of sales or the sales amount of which is high, but also uses the state of stock of each merchandise obtained from the register information and new merchandise recommended by each store, as information for creating merchandise showing information.

Then, the showing image generation unit 12 of the display information generation server device 1 writes and stores the created merchandise showing information in the merchandise showing information table of the showing image database 14, which has already been described. Here, the merchandise showing information is information of a merchandise image to be displayed on the image display unit 22, which is supplied from the head office to each store. That is to say, when the merchandise showing information is supplied to each store, then for each merchandise showing screen indicated by the merchandise showing screen identification information, this at least has display position information, resolution information, additional information of the merchandise, and a merchandise appearance image index (or the actual image data of the merchandise appearance image) of the merchandise image. In the case of the merchandise appearance image index, image data of the merchandise appearance image is accumulated in one of the servers connected to the network 100, and the image information control unit 21 reads the image data of the merchandise appearance image from the server and displays it on the merchandise showing screen.

In addition, the display information generation server device 1 supplies the merchandise showing information created by the showing image generation unit 12 to the image display system 2 of each store at predetermined time intervals. At this time, so as to correspond to the store identification information, the display information generation server device 1 reads from the merchandise showing information table of the showing image database 14, the display position information, the resolution information, the merchandise image index, and the additional information of each merchandise image to be displayed on each merchandise showing screen, and generates merchandise showing information that indicates a merchandise image arrangement on the merchandise showing screen of the image display unit 22 at each store. Moreover, in the case of an operation in which merchandise showing information is changed for each time period, the display information generation server device 1 transmits the merchandise showing information to the image display system 2 of the store at predetermined time intervals. Moreover, the configuration may be such that, at predetermined time intervals, the display information generation server device 1 generates merchandise showing information on the basis of the merchandise showing information table of the showing image database 14, and supplies it to the image display system 2 of each store.

As described above, the display information generation server device 1 supplies to a predetermined store, merchandise showing information that indicates; merchandise sold at the predetermined store, and a display position on the merchandise showing screen included in the display system provided at this store on which the merchandise image, which is an image of the merchandise, is to be displayed. Moreover, the display information generation server device 1 supplies to another store, merchandise showing information that indicates merchandise sold at this another store, and a display position on the merchandise showing screen included in the display system provided in this another store on which the merchandise image is to be displayed. Before generating merchandise showing information to be supplied to each of the predetermined store and another store, the merchandise category associated with the category region on the merchandise showing screen at each store is set. Then the merchandise showing information to be supplied to each of the predetermined store and another store is generated on the basis of each category region.

In addition, the display information generation server device 1 may preliminarily send, on the day before the day of displaying it, each merchandise showing information corresponding to each of the plurality of time periods. In this case, on the store side, the image information control unit 21 preliminarily writes a plurality of merchandise showing information in a storage unit (not shown in the figure). Then, on the basis of the merchandise showing information corresponding to the time period, the image information control unit 21 displays, on the merchandise showing screen, which is the display screen of the image display unit 22, each of the display images of the merchandise in an individual region at the associated display position. The individual region is an individual region of the category region itself or one of divided multiple category regions, for displaying an image of merchandise.

In addition, in the merchandise showing information, as described above, the merchandise category of the merchandise image to be displayed in the individual region is associated with the category region of the merchandise showing screen. Therefore, the merchandise image is displayed in the individual region (designated by the display position) included in the category region associated with the merchandise category of the merchandise on the merchandise showing screen.

The above category region is set as a rule, before supplying the merchandise showing information. More specifically, before the merchandise showing information is generated at the head office, the category region is set as a rule for displaying a merchandise image of each merchandise category on the merchandise showing screen by analyzing the sales situation such as the number of sales and the sales amount of each merchandise by season (month and date), the day of the week, and weather corresponding to the date and time period of the merchandise showing information generation target. In this way, whether to display, in each of the individual regions indicated by the display position on the merchandise showing screen for each store, the merchandise of a merchandise category associated with the category region that includes this individual region, is preliminarily set as a rule, and the display information generation server device 1 generates merchandise showing information according to or in consideration of the rule.

Moreover, in a store where only one merchandise showing screen is arranged, in the region closer to the doorway of the store on the merchandise showing screen and in the region closer to the far side of the store on the merchandise showing screen respectively, category regions that are each associated with different types of merchandise categories are set. The category region of the region closer to the doorway is associated with a merchandise category that attracts customers' interests. In addition, when it is predicted that the category is a merchandise category with high sales, the region to be occupied by the category region of this merchandise category in the merchandise showing screen is set large in advance.

Also, in each rule described in each of the figures described later, processing for generating similar merchandise showing information is performed. The above rules are preliminarily written and stored in the store analysis database 13 for each store. The showing image generation unit 12 of the display information generation server device 1 reads out the rule stored in the store analysis database 13 so as to correspond to the store identification information of the store for which the merchandise showing information is generated, and makes reference to the rule to be displayed on the display screen of the display information generation server device 1. The showing image generation unit 12 associates the layout of the arrangement of the merchandise images on the merchandise showing screen on the display screen of the display information generation server device 1 in accordance with the above rule, that is to say, the processing of arranging the merchandise images in the individual regions of the category region on the merchandise showing screen is performed and the merchandise showing information is generated. At this time, the showing image generation unit 12 executes the process of laying out the merchandise images on the display screen of the display information generation server device 1 according to the operation of the operator at the head office.

Then, on the store side, the image information control unit 21 displays and shows the merchandise image on the merchandise showing screen of the image display unit 22, corresponding to the merchandise showing information supplied from the head office. The image display unit 22 has a merchandise showing screen on which the merchandise is displayed. This merchandise showing screen is configured with the display screen of one or a plurality of image display devices. That is to say, in the case where the image display unit 22 is configured with one image display device, the merchandise showing screen is the display screen itself of this image display device. On the other hand, in the case where the image display unit 22 is configured with a plurality of image display devices, the merchandise showing screen is a composite display screen that combines the plurality of image display devices.

In the store, instead of a display shelf or a refrigerator (refrigerated reach-in-showcase), there is provided the merchandise showing screen of the image display unit 22 according to the present exemplary embodiment. All of the display of the merchandise sold at the store may be replaced by the merchandise showing screen, or a part of the display of the merchandise may be replaced with the merchandise showing screen. Merchandise shown and displayed on the merchandise showing screen are stored in a backyard of the store. In the present exemplary embodiment, at the time of settling the payment for the merchandise, the actual merchandise is taken out from the backyard and is handed to the customer. The position where the merchandise showing screen is installed in the image display unit 22 of the image display system 2 is set for each store by a staff on the store side and a person in charge on the head office side according to the environment around the store and the customer demographics. That is to say, since the merchandise category of hot-selling merchandise and the merchandise category of merchandise to be sold as featured merchandise differ from one store to another, it is determined at which position among the position in the vicinity of the entrance of the store, the position in the vicinity of the center part of the store, and the position in the vicinity of the far end of the store, the installation is to be made, according to the arrangement of hot-selling merchandise or the arrangement of featured merchandise.

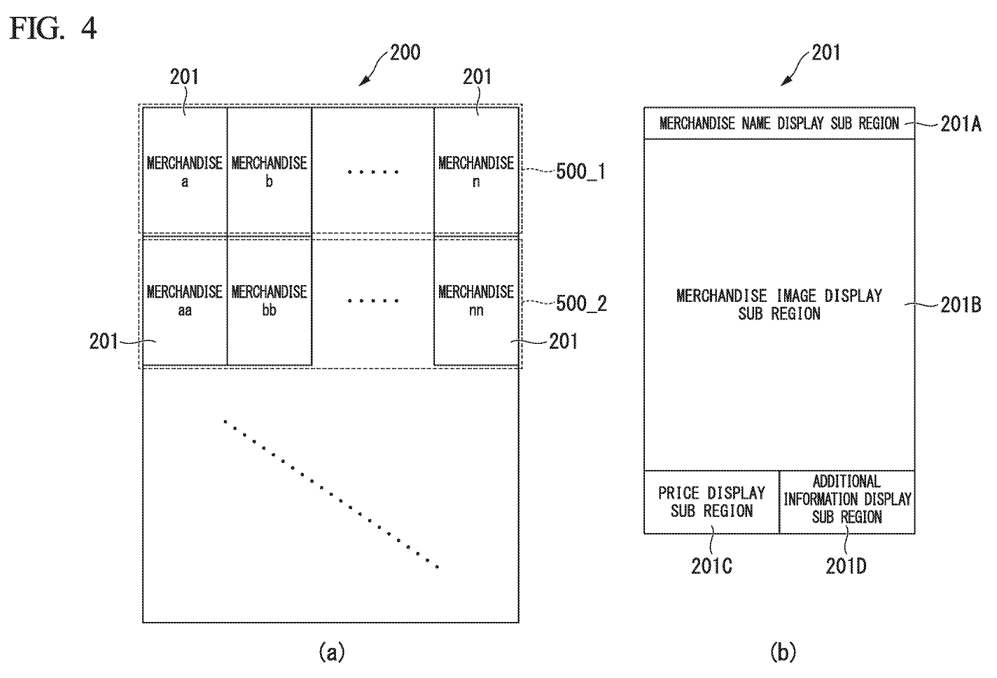

FIG. 4 is a diagram showing an example of the merchandise showing screen of the image display unit 22 constituted by one image display device. FIG. 4 (a) is a configuration example for describing a relationship between display position of the merchandise image on the image display unit 22, and the merchandise category. A merchandise showing screen 200 is divided by a plurality of, that is, two category regions, namely, 500_1 and 500_2. In a category region 202, the category region 500_1 and the category region 500_2 are each associated with one merchandise category or a plurality of merchandise categories.

Moreover, the category region 500_1 and the category region 500_2 are each divided into one individual region 201 or a plurality of individual regions 201. That is to say, the merchandise showing screen 200 is divided into a plurality of individual regions, and each individual region is associated with one or a plurality of predetermined category regions. In FIG. 4 (a), the individual regions 201 are disclosed as being divided into the same size. However, it is not necessary for each individual region 201 to have the same size. For example, it is desirable that the individual regions are divided into a size that allows the merchandise of the merchandise category to be displayed in the actual size. The display position information in the merchandise showing information is information indicating the position of the individual region 201, and, for example, is a coordinate value representing the merchandise showing screen as a two-dimensional coordinate system by the number of pixels. In addition, the merchandise image to be displayed in the individual region may be an image that is larger than the actual size of the merchandise, according to both the shape and the size of the plurality of category regions set on the merchandise showing screen 200, or to either the shape or the size.

The individual regions 201 denoted on the first row as the merchandise a, the merchandise b, . . . , and the merchandise n in the merchandise showing screen 200 belong to the category region 500_1 associated with the merchandise category A (for example, drink). Moreover, the individual regions 201 denoted as the merchandise aa, the merchandise bb, . . . , and the merchandise nn in the merchandise showing screen 200 belong to the category region 500_2 associated with the merchandise category B (for example, lunch box). As with this example in FIG. 4, the category region 500_1 and the category region 500_2 of the merchandise showing screen 200 are each associated with the merchandise category of the merchandise to be displayed therein, and each of the individual regions 201 belongs thereto. Association of the merchandise category with this category region may, in a case where decision making is carried out upon mutual consultation between the store side and the head office side when installing the image display device, be set, before generating merchandise showing information, for each combination of the season (month and date), the day of the week, the time period, the weather, and the like of the day of generating merchandise showing information in some cases.

The consciousness of a customer views the display image sequentially from the merchandise image of the individual region in the upper left (at least the upper portion). For this reason, it is necessary to associate the recommended merchandise category with the category region that includes the individual region in the upper left. In the merchandise category of the merchandise sold at the store, the merchandise categories are associated sequentially from the category region including the upper left individual region, so as to correspond to the recommended order of the merchandise category of the recommended merchandise. Therefore, as already described above, the relationship between the category region and the merchandise category associated with this category region, is set in advance as a rule for each store. In the category region, the number of individual regions is determined by the number of merchandises of the recommended merchandise category. Therefore, the number of individual regions of the merchandise category having many recommended merchandises is increased, and the display area occupied in the merchandise showing screen by the category region associated with the merchandise category is larger than the category region associated with the merchandise category having the smaller number of merchandises.

In accordance with this rule, the showing image generation unit 12 selects merchandise to be displayed on each of the individual regions on the merchandise showing screen of the image display system 2, from the merchandise of the associated merchandise category. Further, also in the plurality of individual regions 201 associated with the same merchandise category, for example, in the individual regions 201 included in the category region 202 associated with the merchandise category A, there is set a rule in which the display position associated with the merchandise is set in the individual region 201 from the upper left in the order of the recommended merchandise in the merchandise group in the merchandise category A.

FIG. 4 (b) is a diagram showing a display example of the merchandise image in each of the individual regions included in the category region 202 of the merchandise showing screen 200. A merchandise image is displayed in the individual region 201, and in the region there are provided a merchandise name display sub region 201A in which the character information of a merchandise name is displayed, a merchandise image display sub region 201B in which the merchandise shape image of a merchandise itself is displayed, a price display sub region 201C in which the character information of price is displayed, and an additional information display sub region 201D in which additional information of a merchandise is displayed. That is to say, the image information control unit 21 extracts, for each merchandise identification information, a merchandise name, merchandise shape image data, display position information, and additional information from the merchandise showing information, and displays it in the individual region 202 included in the category region 202 indicated by the display position information in the merchandise showing screen 200 of the image display unit 22 according to the resolution of the indicated resolution information.

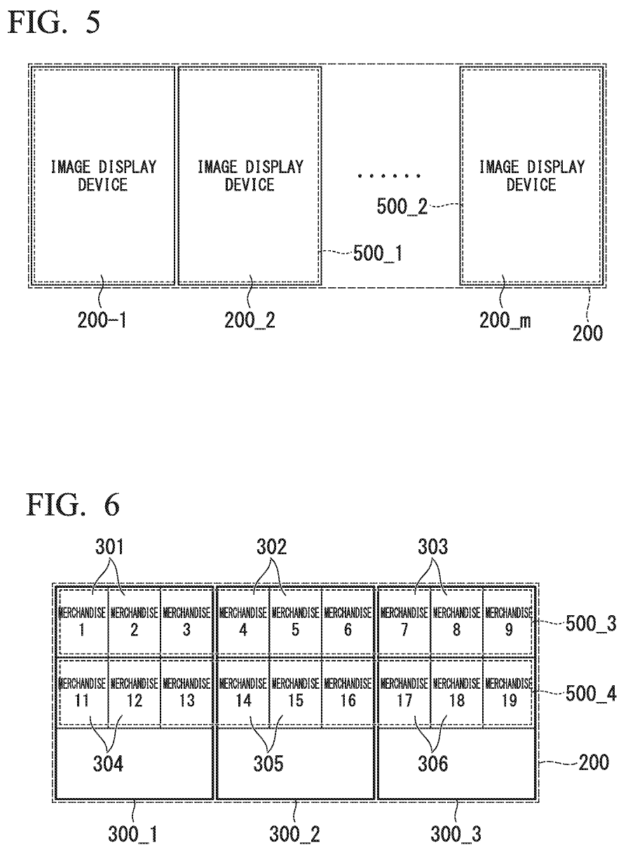

FIG. 5 is a diagram showing another example of the merchandise showing screen in which merchandise categories are associated. On the basis of the merchandise showing information, the image information control unit 21 displays the merchandise image of the merchandise on the merchandise showing screen of the image display unit 22, as shown in FIG. 5. In FIG. 5, the merchandise showing screen 200 includes a composite display screen of display screens of an image display device 200_1, an image display device 200_2, . . . , and an image display device 201_n. In the case of FIG. 5, each merchandise category is associated with each category region of the merchandise showing screen which is the composite display screen of the image display device 200_1, the image display device 200_2, . . . , and the image display device 201_n. That is to say, the merchandise category A is associated with the category region 500_1 that includes the display screens of the image display devices 200_1 and 2001_2. Therefore, in each of the individual regions in the category region 500_1, the merchandise of the merchandise category A is displayed, respectively. Moreover, the merchandise category B is associated with the category region 500_2 that includes the display screen of the image display device 200_n. In each of the individual regions in the category region 500_2, the merchandise of the merchandise category B are displayed, respectively.

FIG. 6 is a diagram showing another example of the merchandise showing screen in which merchandise categories are associated. On the basis of the merchandise showing information, the image information control unit 21 displays the merchandise image of the merchandise on the merchandise showing screen 200 of the image display unit 22, as shown in FIG. 6. In FIG. 6, the merchandise showing screen 200 includes a composite display screen of display screens of an image display device 300_1, an image display device 300_2, and an image display device 300_3. The merchandise showing screen 200 is divided into a plurality of category regions such as a category region 500_3 and a category region 500_4. Each of the category regions 500_3 and the category region 500_4 is composed of predetermined display screen regions of the image display device 300_1, the image display device 300_2, and the image display device 300_3.

The category region 500_3 includes an individual region 301, an individual region 302, and an individual region 303 respectively. The category region 500_4 includes an individual region 304, an individual region 305, and an individual region 306 respectively. In the case of FIG. 6, the category region 500_3 composed of the individual region 301, the individual region 302, and the individual region 303 on the first row on the display screen of each of the image display device 300_1, the image display device 300_2, and the image display device 300_3, is associated with the merchandise category A. Moreover, the individual region 304, the individual region 305, and the individual region 306 on the second row of the display screen of each of the image display device 300_1, the image display device 300_2, and the image display device 300_3, are each associated with the merchandise category B. That is to say, the category region 500_3 of the first row of the merchandise showing screen is associated with the merchandise category A, and the category region 500_4 of the second row of the merchandise showing screen is associated with the merchandise category B. In this way, merchandise categories may be associated across different image display devices.

Further, the image display device 300_3 may be disposed adjacent to the image display device 300_2, or may be disposed at a different position apart from both of the image display device 300_1 and the image display device 300_2. In addition, each of the image display device 300_1, the image display device 300_2 and the image display device 300_3 constituting the merchandise showing screen 200 may be arranged at different positions.

FIG. 7 is a diagram showing another example of the merchandise showing screen in which merchandise categories are associated. On the basis of the merchandise showing information, the image information control unit 21 displays the merchandise image of the merchandise on the merchandise showing screen 200 of the image display unit 22, as shown in FIG. 7. In FIG. 7, the merchandise showing screen 200 includes a composite display screen of display screens of an image display device 400_1, and an image display device 400_2. The merchandise showing screen 200 is divided into a plurality of category regions such as a category region 500_5, a category region 500_6, and a category region 500_7. The category region 500_5 is composed of an individual region 307 (the first row) on the merchandise showing screen 200. Moreover, the category region 500_6 is composed of an individual region 308 (the second row) and an individual region 309 (the third row) respectively on the merchandise showing screen 200. Each of the individual region 307, the individual region 308, and the individual region 309 is configured to extend over each of an image display device 400_1 and an image display device 400_2 (including a part of the display screen of each of the plurality of image display devices). That is to say, each of the individual region 501, the individual region 502, and the individual region 503 is an individual region formed by connecting a region obtained by dividing the adjacent image display device 400_1 in units of rows, and a region obtained by dividing the image display device 400_2 in units of rows.

Each of a category region 500_7 and a category region 500_8 is composed of an individual region 401 in the image display device 400_1 and an individual region 402 in the display device 400_2.

The category region 500_5, the category region 500_6, the category region 500_7, and the category region 500_8 described above are each associated with the same merchandise category or different merchandise categories. Moreover, in each of the individual region 307, the individual region 308, and the individual region 309, a merchandise image of one type of merchandise of a merchandise category associated with each merchandise category is displayed. As described above, the area of the individual region occupying the category region may be changed so as to correspond to the degree of recommendation. That is to say, as the degree of recommendation increases, the area of the individual region is set to increase. The merchandise appearance image to be displayed in the individual region is not limited to a still image but may be a motion image that increases the impact of the recommended merchandise, for example, a motion image similar to an image of a commercial broadcast on the television.

Furthermore, in FIG. 7, in the individual regions 401 (image display device 400_1) included in the category region 500_7 of the fourth row, merchandise images of a merchandise 1, merchandise 2, merchandise 3, merchandise 4, and merchandise 5 of the merchandise category associated with the category region 500_7, are displayed respectively. In the individual regions 402 (image display device 400_2) included in the category region 500_7 of the fourth row, merchandise images of a merchandise 6, merchandise 7, merchandise 8, merchandise 9, and merchandise 10 of the merchandise category associated with the category region 500_7, are displayed respectively.

In addition, in the case where a plurality of merchandise categories, for example, a merchandise category A and a merchandise category B are associated with the category region 500_7 in the fourth row, the merchandise image of a merchandise of the merchandise category A may be displayed in each individual region 401 and the merchandise image of a merchandise of the merchandise category B may be displayed in each individual region 402.

In the individual regions 401 (image display device 400_1) included in the category region 500_8 of the fifth row, merchandise images of a merchandise 11, merchandise 12, merchandise 13, merchandise 14, and merchandise 15 of the merchandise category associated with the category region 500_8, are displayed respectively. In the individual regions 402 (image display device 400_2) included in the category region 500_8 of the fifth row, merchandise images of a merchandise 16, merchandise 17, merchandise 18, merchandise 19, and merchandise 20 of the merchandise category associated with the category region 500_8, are displayed respectively.

In addition, as with the fourth row, in the case where a plurality of merchandise categories, for example, a merchandise category A and a merchandise category B are associated with the category region 500_7 in the fifth row, the merchandise image of a merchandise of the merchandise category A may be displayed in each individual region 401 and the merchandise image of a merchandise of the merchandise category B may be displayed in each individual region 402.

Moreover, as with FIG. 4, the merchandise showing information in FIG. 5, FIG. 6, and FIG. 7 described above is also created by the showing image generation unit 12 in the display information generation server device 1 in accordance with a preliminarily set rule. Here, the display information generation server device 1 may be configured to create the merchandise showing information by an operation of the operator at the head office.

Returning to FIG. 1, on the store side, on the basis of the merchandise showing information, which is basically supplied from the head office, the image information control unit 21 displays the merchandise image of the merchandise on the merchandise showing screen of the image display unit 22 (image display device), as shown in FIG. 5 to FIG. 7.

However, according to the store side judgment, the merchandise category to be associated with a category region on the merchandise showing screen by means of the merchandise showing information, or the type of merchandise to be displayed in an individual region of the category region is changed. For example, a merchandise showing screen (the display screen of the image display device) has a function of a touch panel, and a store staff of the store changes the display position of the merchandise image of merchandise on the touch panel by performing a drag and drop operation on the merchandise image on the touch panel. That is to say, the recommended merchandise categories or recommended merchandise are changed in order to suit situations such as; a case where an unexpected event (such as a sporting event) is taking place, a case of a sudden change in the weather (such as a case of sudden rain, or increase in the temperature due to recovery of the weather), and a case where the stock of the merchandise displayed on the merchandise showing screen is about to run out. Therefore, the position on the merchandise showing screen in the category region, and the display position of the individual region in which the merchandise image of the merchandise in the category region is displayed are changed as required by the store according to circumstances. That is to say, the store staff of the store displays the merchandise image of the merchandise on the merchandise showing screen on the basis of the merchandise showing information supplied from the head office or information that has been changed by a partial correction made of the merchandise showing information.

Moreover, processing of a point-of-purchase advertising may be performed by selecting a fluorescent color on the touch panel for the merchandise image corresponding to the merchandise showing information on the merchandise showing screen, and writing characters and/or images on the merchandise image of the merchandise displayed in the individual region of the category region. For example, for a portion in which the price of merchandise on the merchandise showing screen is displayed by the merchandise showing information, the store staff may perform processing such as writing a point-of-purchase advertising on the touch panel by means of a finger or a pen, such as “price reduced, 30-yen discount on displayed price”, “a suitable drink for a very hot day”, and “get 50-yen discount on drink when buying with lunch box”.

As described above, in the present exemplary embodiment, the display format of the merchandise image displayed in the category region and the individual region on the merchandise showing screen is finally adjusted by the store so as to correspond to the situation that changes every moment.

As a result, according to the present invention, it is possible to arrange images of merchandise on the merchandise showing screen of the image display system 2, on the basis of sales performance confirmation on the POS system of the head office and merchandise showing image information that indicates a configuration of merchandise showing display images generated by a specialized staff having know-how of extracting hot-selling merchandise, which are supplied from the head office. Therefore, there is no need for confirming sales performance on the register information of the POS system at each store, or extracting hot-selling merchandise, and it is possible to easily obtain an arrangement of merchandise images to be shown and displayed, in the merchandise category associated with the category region on the merchandise showing screen that improves sales, or in each individual region in the category region.

That is to say, according to the exemplary embodiment, the specialized staff from the head office supplies, to each store as merchandise showing information, a merchandise category associated with a category region, an arrangement position on the merchandise showing screen of the category region, determination of the position of an individual region in the category region, and a display configuration of the merchandise showing screen such as the type of merchandise to serve as a merchandise image, which are difficult to prepare on the store side without specialized knowledge of register information analysis and image designing. Therefore, it is possible to effectively present to the customer, hot-selling merchandise or recommended merchandise at each store on the merchandise showing screen of the image display system 2.

Furthermore, according to the present exemplary embodiment, since the merchandise showing screen based on the merchandise showing information supplied from the head office can be arbitrarily changed by the store side according to the store's current situation, it is possible to present to the customer the merchandise image of merchandise of a merchandise category desired to be sold to a customer flexibly, and it is possible to improve sales of merchandise in accordance with the change in the hot-selling merchandise depending on the situation.

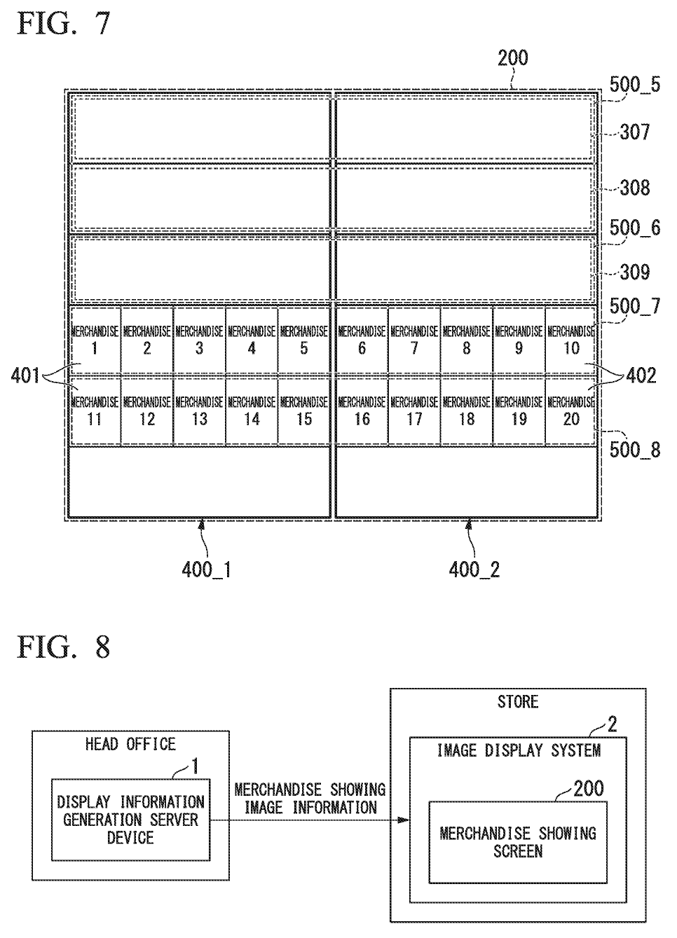

FIG. 8 is a diagram for describing a concept of the exemplary embodiment of the present invention. The image display system 2 is provided in each of the stores, and displays merchandise images which are images of merchandise sold by each store on the merchandise showing screen 200, on the basis of the merchandise showing information supplied from the head office. This merchandise showing information is information that is supplied to each store from the head office and that indicates the individual region of which position on the merchandise showing screen 200 the merchandise image is to be displayed. The display information generation server device 1 of the head office generates the merchandise showing information and supplies it to each store.

Further, the control for realizing each of the function of generating the merchandise showing information for displaying the showing image of the merchandise of the display information generation server device 1 in FIG. 1, and the function of displaying the showing image of the merchandise of the image display system 2, may be performed by an external computer system. It should be noted that the “computer system” referred to here includes an operating system and hardware such as peripheral devices.

Although the exemplary embodiment of the present invention has been described in detail with reference to the drawings, the specific configuration is not limited to this exemplary embodiment, and includes designs and the like within the scope not departing from the gist of the present invention.

### INDUSTRIAL APPLICABILITY

Each of the display information generation server device 1 and the image display system 2 described above can be applied not only to stores such as supermarkets and convenience stores, but also to showing display of merchandise at retail premises such as restaurants and book stores, and at department stores.

### REFERENCE SYMBOLS

1 Display information generation server device
2 Image display system
3 Register information management unit
4 Weather server
11 Information analysis unit
12 Showing image generation unit
13 Store analysis database
14 Showing image database
21 Image information control unit
22 Image display unit
31 Register information input and output unit
32 Register information storage unit
100 Network

1. An information supply method comprising:
supplying a store with merchandise showing information, the merchandise showing information indicating merchandise sold at the store and a position at which a merchandise image is displayed, the position being a position on a merchandise showing screen of a display system provided at the store, the merchandise image being an image of the merchandise.

2. The information supply method according to claim 1, wherein a category region is set in advance before the merchandise showing information is supplied, the category region being a region on the merchandise showing screen and being a region with which a merchandise category is associated, and the merchandise category being a category of the merchandise.

3. The information supply method according to claim 2, wherein the merchandise showing information is generated based at least on the category region.

4. The information supply method according to claim 2,
wherein the category region comprises one category region of a plurality of category regions which are set on the merchandise showing screen, and
a category of the merchandise indicated by the merchandise showing information is a merchandise category associated with either one of the plurality of category regions set on the merchandise showing screen.

5. The information supply method according to claim 2, wherein the merchandise showing screen is constituted by a display screen of each of a plurality of display devices included in the display system.

6. The information supply method according to claim 5, wherein the merchandise showing screen indicates, as the position at which the merchandise image is displayed, one of the plurality of display devices and a position on the display screen.

7. The information supply method according to claim 1, wherein the category region comprises one category region of a plurality of the category regions set on the merchandise showing screen, and the plurality of category regions are each set in advance at each predetermined time period.

8. The information supply method according to claim 7, wherein the merchandise showing information is supplied to the shop at least at each predetermined time period.

9. The information supply method according to claim 1,
wherein on the merchandise showing screen, a plurality of individual regions are set in advance before the merchandise showing information is supplied, and
the merchandise showing information indicates one individual region of the plurality of individual regions, as the position at which the merchandise image is displayed.

10. The information supply method according to claim 1, wherein the merchandise showing information is information based on at least information of a point of sale (POS) system of the store.

11. A merchandise display method comprising:
the information supply method according to claim 1,
wherein the merchandise image is displayed on the merchandise showing screen, based on the merchandise showing information, or information obtained by modifying a part of the merchandise showing information.

12. A merchandise display method comprising:
the information supply method according to claim 2,
wherein the category region comprises one category region of a plurality of category regions set on the merchandise showing screen, and the merchandise image larger than an actual size of the merchandise is displayed according to a shape and/or size of the plurality of category regions.

13. An information supply method comprising:
supplying a first store with first merchandise showing information, the first merchandise showing information indicating first merchandise sold at the first store and a first position at which first merchandise image is displayed, the first position being a position on a first merchandise showing screen that a first display system has, the first display system being provided at the first store, and the merchandise image being an image of the first merchandise; and
supplying a second store with second merchandise showing information, the second merchandise showing information indicating second merchandise sold at the second store and a second position at which second merchandise image is displayed, the second position being a position on a second merchandise showing screen that a second display system has, the second display system being provided at the second store, and the merchandise image being an image of the second merchandise.

14. The information supply method according to claim 13,
wherein a first category region is set in advance before the first merchandise showing information is supplied, the first category region being a region on the first merchandise showing screen and being a region with which a first merchandise category is associated, and the first merchandise category being a category of the first merchandise, and
a second category region is set in advance before the second merchandise showing information is supplied, the second category region being a region on the second merchandise showing screen and being a region with which a second merchandise category is associated, and the second merchandise category being a category of the second merchandise.

15. The information supply method according to claim 14,
wherein the first merchandise showing information is generated based on at least the first category region, and
the second merchandise showing information is generated based on at least the second category region.

16. A display information generation server device that is provided at a head office that administers a store, and that supplies the store with merchandise showing image information, the merchandise showing information indicating merchandise sold at the store and a position at which a merchandise image is displayed, the position being a position on a merchandise showing screen of a display system provided at the store, the merchandise image being an image of the merchandise.

17. An image display system comprising one or a plurality of image display devices provided in a store, the system comprising:
a merchandise showing screen constituted by a display screen of the image display devices; and
an image information control unit that displays an image of merchandise on the merchandise showing screen based on merchandise showing information, the merchandise showing information indicating merchandise sold at the store and a position at which a merchandise image is displayed, the position being a position on a merchandise showing screen of a display system provided at the store, the merchandise image being an image of the merchandise.
